(19) United States
(12) Patent Application Publication
(10) Pub. No.: US 2026/0146505 A1
(43) Pub. Date: May 28, 2026

(54) Rapid Separation Conduit

(71) Applicants: Kinetic Pressure Control Ltd., Houston, TX (US); HESS Corporation, Houston, TX (US)

(72) Inventors: Steven A. Angstmann, Houston, TX (US); Myles Barret, Houston, TX (US)

(73) Assignees: Kinetic Pressure Control Ltd., Houston, TX (US); HESS Corporation, Houston, TX (US)

(21) Appl. No.: 19/121,593

(22) PCT Filed: Sep. 25, 2023
(86) PCT No.: PCT/US2023/033570

§ 371 Date: Apr. 16, 2025

Related U.S. Application Data
(60) Provisional application No. 63/417,648, filed on Oct. 19, 2022.

(51) Int. Cl. E21B 17/06; E21B 17/01; E21B 17/08; E21B 33/038

(52) U.S. Cl. CPC E21B 17/06; E21B 17/01; E21B 17/085; E21B 33/038

(57) ABSTRACT

A rapidly separable conduit includes a pair of linked coupling members forming a fluid conduit with a primary through bore. The coupling members are each configured with passages to form secondary through bores separate and apart from the primary through bore. Explosively frangible fasteners configured for electronic triggering to set off explosive charges maintain the coupling members joined together. The explosively charges are sealed off from the external environment. Methods for rapidly separating a conduit.

### CROSS REFERENCE TO RELATED APPLICATIONS

This is a national stage application of International Application No. PCT/US2023/033570 filed on Sep. 25, 2023, which claims priority from U.S. Provisional Application No. 63/417,648 filed on Oct. 19, 2022. The foregoing applications are incorporated herein by reference in their entirety.

### BACKGROUND

This disclosure relates to the field of fluid conveyance and control apparatus. More particularly, the disclosure relates to methods and devices for quickly disconnecting or separating conduits on fluid conveyance systems.

Marine oil and gas operations entail the conveyance of hydrocarbons from the sea floor to a body (e.g., a vessel or platform) at the water surface. Specially constructed tubulars known as “risers” are used to convey fluids between the subsea equipment and the surface bodies. The subsea equipment in wellbore drilling operations includes the use of a pressure control apparatus such as a blowout preventer (“BOP”) disposed near the wellhead. These pressure control devices and other apparatus may be connected to each other near the sea floor to form a BOP stack.

In certain situations, for example adverse weather conditions, it is desirable to move the riser extending between the BOP stack and the surface body away from the well location. It then becomes necessary to disconnect the riser from the stack. Disconnection may be performed, for example, by uncoupling connection joints in the stack after closing one or more pressure control elements in the stack. Uncoupling may include, for example, unthreading threaded connectors, removing coupling bolts from mating flanges and/or releasing a profile connector by rotating components of the stack.

Disconnecting from the stack in a station-keeping emergency is a very important function for a stack. It is known in the art to take one minute or longer to complete an emergency disconnect. Conventional disconnection methods often require that disconnection decisions be made early. For example, dynamic positioning watch circles need to consider the disconnect time. In addition, permissible connector release angles can be smaller than flex joint angle ratings. That is, the stack apparatus release angle can be governing as to the amount of movement permissible by the surface body during disconnect operations.

Thus, a need remains for improved conduit separation techniques, especially under extreme conditions requiring rapid release and in underwater environments.

### SUMMARY

A rapidly separable conduit according to an aspect of the present disclosure includes a first coupling member; a second coupling member configured to connect with the first coupling member to form a fluid conduit having a primary through bore; wherein the first and second coupling members are each configured with passages to form at least one secondary through bore separate and apart from the primary through bore; wherein the first and second coupling members are configured to accept at least one explosively frangible fastener to maintain the first and second coupling members joined to one another when the fluid conduit is formed; wherein the at least one explosively frangible fastener is configured for electronic triggering to set off an explosive charge disposed thereon; and wherein the explosively charge is sealed off from the external environment when the fluid conduit is formed.

A method for rapidly separating a conduit according to an aspect of the present disclosure includes electronically triggering the detonation of an explosive charge on one or more explosively frangible fasteners disposed on a conduit comprising a first coupling member connected to a second coupling member; wherein the explosive charge is sealed off from the external environment; wherein the conduit comprises a primary through bore for fluid passage and at least one secondary through bore for fluid passage separate and apart from the primary through bore; and permitting separation of the first coupling member from the second coupling member upon the detonation of the explosive charge on the one or more explosively frangible fasteners on the conduit.

Other aspects of the embodiments described herein will become apparent from the following description and the accompanying drawings, illustrating the principles of the embodiments by way of example only.

### BRIEF DESCRIPTION OF THE DRAWINGS

The following figures form part of the present specification and are included to further demonstrate certain aspects of the present disclosure and should not be used to limit the claimed subject matter. A more complete understanding of the disclosed embodiments and further features and advantages thereof may be acquired by referring to the following description taken in conjunction with the accompanying drawings, in which like reference numerals may identify like elements, wherein:

FIG. 1 shows a perspective view of an example embodiment of a conduit consisting of two coupled members according to the present disclosure.

FIG. 2 shows a perspective view from the other end of the conduit embodiment of FIG. 1.

FIG. 3 shows a partial cross-section of an example embodiment of a conduit according to the present disclosure.

FIG. 4 shows a cross-section of the conduit of FIG. 3 across the section labelled A-A in FIG. 3.

FIG. 5 shows a plan view of an example embodiment of an explosively frangible nut according to the present disclosure.

FIG. 6 shows a perspective view of an example embodiment of an explosively frangible nut according to the present disclosure.

FIG. 7 shows a cross-section side view of an example embodiment of an explosively frangible nut according to the present disclosure.

FIG. 8 shows a cross-section of a conduit embodiment according to the present disclosure.

FIG. 9 shows an exploded view of an example embodiment of a conduit showing two coupling members according to the present disclosure.

FIG. 10 shows a schematic of an example embodiment of a conduit coupled in a fluid conveyance system disposed underwater according to the present disclosure.

### DETAILED DESCRIPTION

The foregoing description of the figures is provided for the convenience of the reader. It should be understood, however, that the embodiments are not limited to the precise arrangements and configurations shown in the figures. Also, the figures are not necessarily drawn to scale, and certain features may be shown exaggerated in scale or in generalized or schematic form, in the interest of clarity and conciseness. In the development of any actual embodiment, numerous implementation-specific decisions may need to be made to achieve the design-specific goals, which may vary from one implementation to another. It will be appreciated that such a development effort, while possibly complex and time-consuming, would nevertheless be a routine undertaking for persons of ordinary skill in the art having the benefit of this disclosure. The following detailed description of exemplary embodiments, read in conjunction with the accompanying drawings, is merely illustrative and is not to be taken as limiting the scope of the invention.

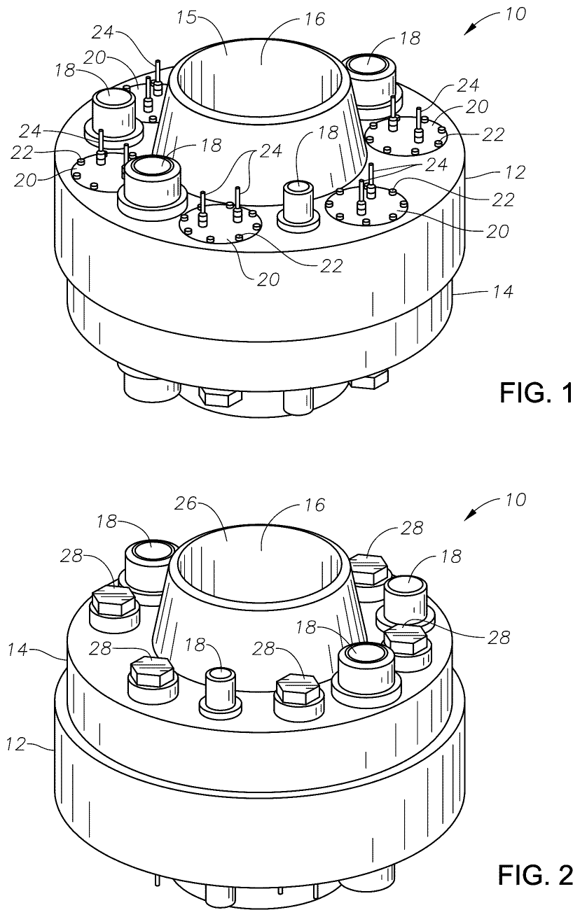

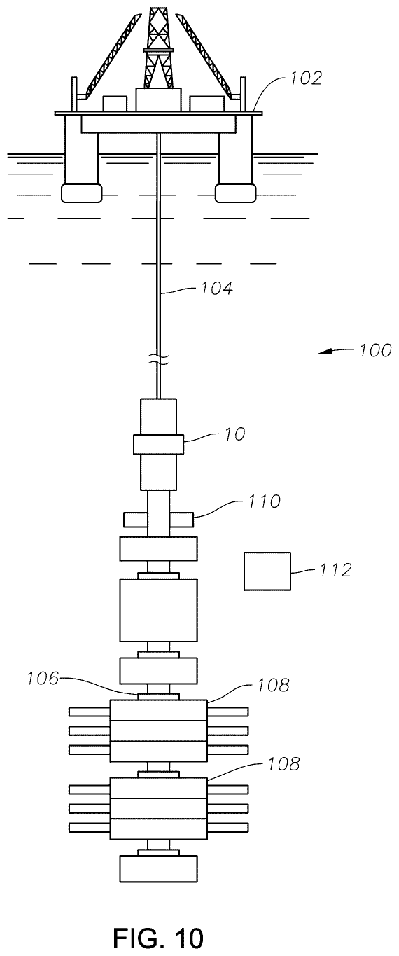

FIG. 1 shows an example embodiment of a conduit 10 according to this disclosure. The conduit 10 includes a first coupling member 12 coupled to a second coupling member 14. The first coupling member 12 has a central opening 15 forming a primary through bore 16 passing through the entire conduit from one end to the other to permit fluid passage therethrough. The first 12 and second 14 coupling members are each configured with multiple passages that form secondary through bores 18 separate and apart from the primary through bore 16. Each secondary through bore 18 also passes through the entire conduit from one end to the other to permit fluid passage therethrough, separate and apart from the primary through bore 16. In oil and gas applications, the secondary through bores 18 may be used to convey fluids (e.g., hydraulic fluid lines, choke and kill lines, booster lines, etc.) to/from apparatus coupled into the fluid conveyance system the conduit 10 is linked to (see FIG. 10).

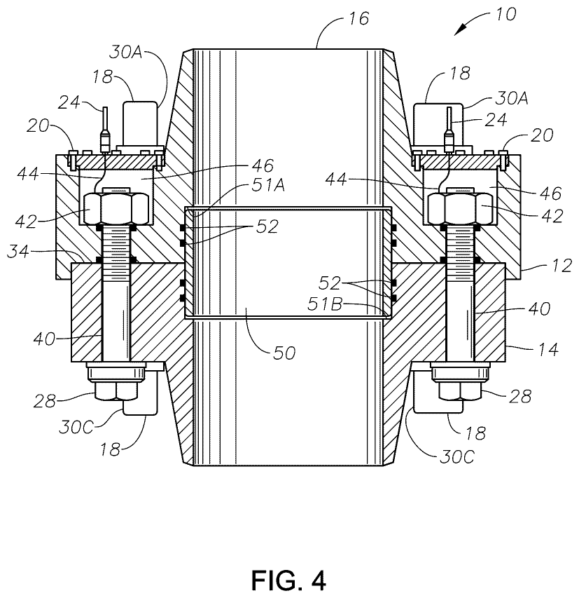

As shown in FIG. 1, the first coupling member 12 is also implemented with sealing covers 20 to seal off housed explosively frangible fasteners from the external environment. The explosively frangible fasteners hold the first 12 and second 14 coupling members coupled together and provide for a rapid separation of the members when actuated (further described below). The individual sealing covers 20 can be secured to the first coupling member 12 via fasteners 22 (e.g., bolts threaded into the coupling member 12 body) or suitable adhesives as known in the art. Some embodiments may be implemented with the sealing covers 20 configured with threads to screw the covers into matching internal threads formed in the coupling member 12 body (see FIG. 4), similar to a lid on a jar. Additional sealing integrity can be provided by adding a seal (e.g. O-ring) to the threaded section of the sealing cover 20. FIG. 1 also shows electrical leads 24 mounted on the sealing covers 20 to provide an electrical connection point for the explosively frangible fasteners positioned under the sealing covers 20.

FIG. 2 shows the conduit 10 of FIG. 1 inverted to reveal the second coupling member 14. As shown, the second coupling member 14 is configured with matching passages to form the secondary through bores 18 when the members are coupled to form the conduit 10. The second coupling member 14 also has a central opening 26 forming the primary through bore 16. FIG. 2 also shows the heads 28 of the explosively frangible fasteners securing the coupling members to one another (see FIG. 4). Although the conduit 10 embodiments of FIGS. 1 and 2 are circular or donut-shaped, it will be appreciated that other embodiments of the disclosed conduits 10 can be implemented with other external shapes, depending on the application.

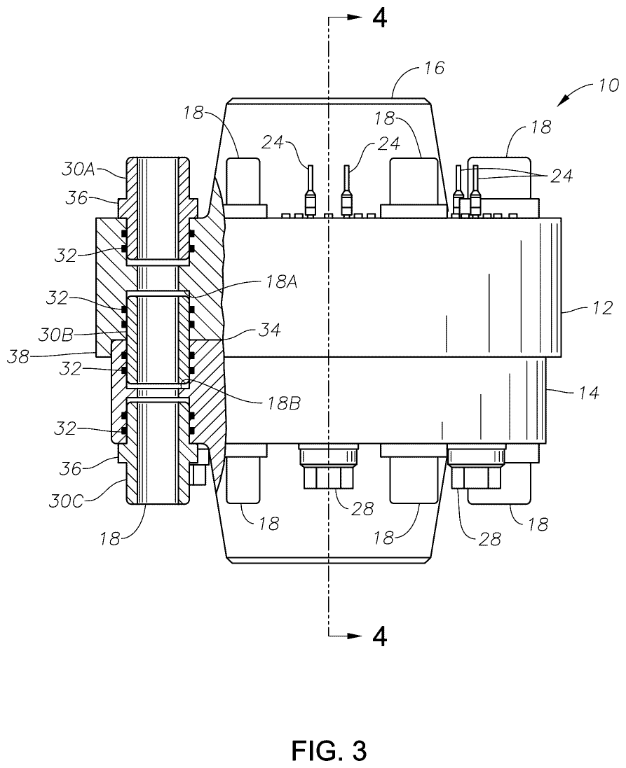

FIG. 3 shows a side view with a partial cross-section of an example embodiment of a conduit 10 according to this disclosure. As shown, embodiments can be implemented with one or more of the secondary through bores 18 housing a set of sleeves 30A, 30B, 30C mounted within the bore. Each sleeve 30A, 30B, 30C includes one or more external seals 32 (e.g. O-rings) to provide greater sealing integrity within the through bore 18. A central sleeve 30B is positioned within the secondary through bore 18 to straddle the junction 34 between the first 12 and second 14 coupling members. This sleeve 30B is implemented with a seal 32 at each end for greater sealing integrity. The secondary through bore 18 on the first 12 and second 14 coupling members may be formed to respectively provide an internal shoulder 18A, 18B to prevent the sleeve 30B from axially moving within the bore when the members are coupled to form the conduit 10. Sleeves 30A and 30C are respectively mounted into the through bore 18 entry of the first 12 and second 14 coupling members. These sleeves 30A, 30C are each configured with an external ring 36 that provides a stop when the sleeves are mounted into the secondary through bore 18. Sleeves 30A and 30C can be permanently mounted within the secondary through bore 18 via conventional techniques (e.g., press fitting, welding, threading to screw into the bore, etc.). FIG. 3 also shows an embodiment wherein the first coupling member 12 is configured with a raised lip 38 running along the circumference of the mating surface to form a receiving shoulder for the second 14 coupling member when the two members are joined together.

FIG. 4 shows a side view cross-section of the conduit 10 of FIG. 3 across the section labelled A-A in FIG. 3. In some embodiments, the explosively frangible fasteners 40 comprise a bolt configured with an explosively frangible nut 42. Each explosively frangible nut 42 is linked to an electrical lead 24 via a wire 44 coupling the two components. As described above, each explosively frangible nut 42 is protected from the external environment as each nut resides in a recess 46 formed on the coupling member 12 body and is sealed by a sealing cover 20. In some embodiments, explosively frangible studs, bolts, or other types of explosively frangible fasteners could be used instead of explosively frangible nuts 42.

The conduit 10 embodiment of FIG. 4 is implemented with a sleeve 50 disposed within the primary through bore 16 to straddle the junction 34 between the first 12 and second 14 coupling members. The primary through bore 16 on the first 12 and second 14 coupling members may be formed to respectively provide an internal shoulder 51A, 51B to prevent the sleeve 50 from axially moving within the bore when the members are coupled to form the conduit 10. This sleeve 50 is implemented with radial seals 52 (e.g. O-rings) at each end for greater sealing integrity of the primary through bore 16.

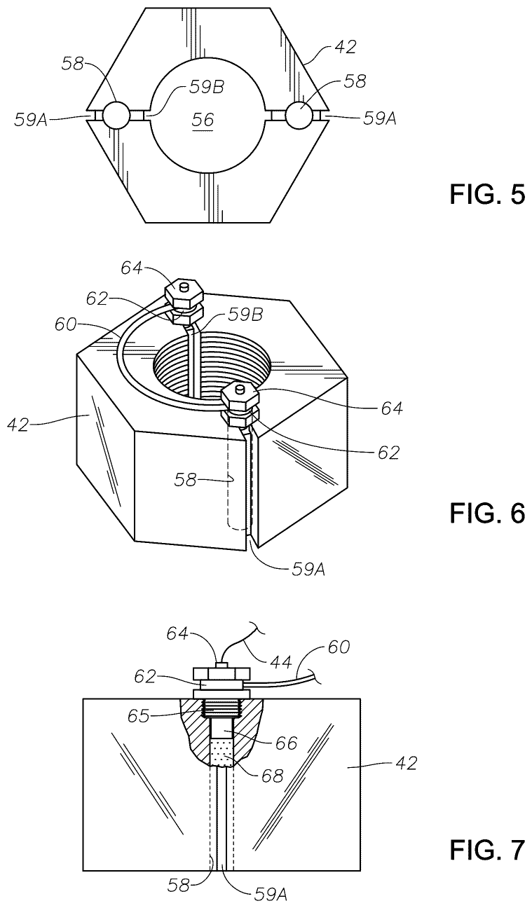

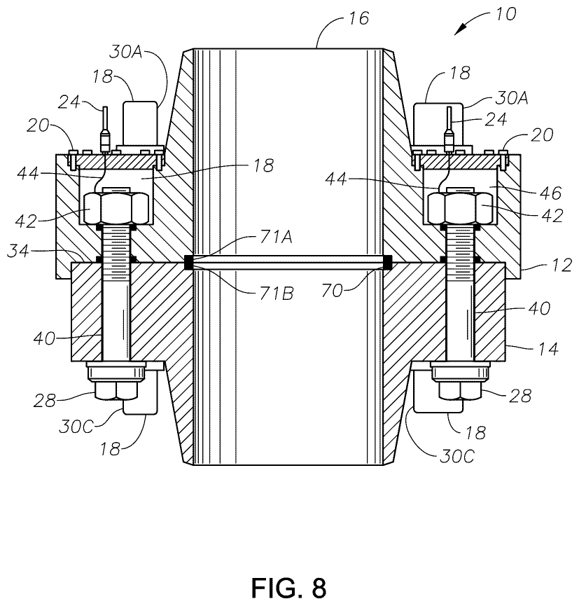

FIG. 5 shows an example embodiment of an explosive frangible fastener, an explosively frangible nut 42. As seen from an overhead view, the nut 42 has a central opening 56 with inner threads to receive and engage a threaded bolt, such as the threaded stud of frangible fastener 40. It will be appreciated by those skilled in the art that although a hexagonal shaped nut 42 is shown in the illustrations herein, embodiments of the nut 42 may be implemented in any configuration or shape available in commerce. In addition to the central threaded opening 56, the nut 42 is configured with one or more voids 58. In some embodiments, the void(s) 58 is cylindrical in shape and runs through the nut 42 body, from top to bottom (see FIG. 7). Voids 58 are preferably located near vertices of the nut 42. Some embodiments are also configured with a void or gap 59A extending from top to bottom along the outer edge of the vertex nearest the void 58. Another void or gap 59B may also be formed running from top to bottom of the nut 42 on the opposite side of the void 58, extending into the central opening 56. Nut 42 embodiments may be formed of any material as known in the art and suitable to allow for the nut to “split” apart upon detonation of an explosive charge as described herein. Conventional frangible nuts may be obtained from suppliers such as Ensign-Bickford Aerospace and Defense Company (https://www.ebad. com) and Pacific Scientific Energetic Materials Company, 7073 West Willis Road, Chandler, Arizona 85226.

FIG. 6 shows another example embodiment of an explosive frangible nut 42. A pyrotechnic crossover 60 is disposed on the nut 42. As known by those skilled in the art, a pyrotechnic crossover 60 (also conventionally known as detonating cord) is essentially a high-speed explosive fuse. The crossover 60 is a thin, flexible tube (e.g., plastic tube or bendable metal sheath) filled with an explosive material such as pentaerythritol tetranitrate (PETN). In this embodiment, the crossover 60 includes a connector 62 at each end. The velocity of detonation of the crossover 60 is sufficient to use it for synchronizing multiple charges to detonate almost simultaneously even if the charges are placed at different distances from the point of initiation. As such, any common length of the crossover 60 appears to explode instantaneously. In the embodiment shown in FIG. 6, one connector 62 of the pyrotechnic crossover 60 is coupled to an initiator 64 disposed within one of the voids 58 in the nut 42. The connector 62 on the other end of the crossover 60 is coupled to a detonator 66 disposed in the other void 58 in the nut 42 (further described with respect to FIG. 7).

FIG. 7 shows a side view of the nut 42 of FIG. 6. In this embodiment, the pyrotechnic crossover 60 connector 62 is coupled to an initiator 64 that is securely engaged with threads 65 formed in the void 58. A suitable conventional initiator 64 may be used to implement the disclosed embodiments (e.g., as provided by PACSI EMC in Chandler, Arizona. https://psemc.com). The initiator 64 is electronically triggered to detonate when a current is applied via wire 44 linking the initiator to a voltage source (not shown). The crossover 60 connector 62 is directly coupled with the initiator 64 such that when the initiator is activated the crossover instantaneously conveys the explosive detonation to the connector 62 at the other end of the crossover.

As shown in FIG. 7, the nut 42 includes a detonator 66 cartridge and an explosive charge 68 disposed within the void 58. A suitable conventional detonator 66 may be used to implement the disclosed embodiments (e.g., as provided by PACSI EMC in Chandler, Arizona. https://psemc.com). Upon activation of the initiator 66 by a current applied via the wire 44, the detonator 66 is ignited, which in turn sets off the explosive charge 68 (e.g. stabilized RDX cartridge). Detonation of the explosive charge 68 within the void 58 causes a sufficient pressure buildup to produce separation of the nut 42. With the gaps 59A, 59B formed on the opposite sides of the void 58, the explosive charge 68 only needs to produce sufficient pressure to separate the material around the void 58. In some embodiments, the crossover 60 may be rated to generate sufficient explosive energy to set off the explosive charge 68 without the need of a detonator 66. Thus, embodiments may be implemented wherein the nut 42 is equipped with one initiator 66 and one explosive charge 68 in one void 58, and another explosive charge in the other void 58, with a crossover 60 linking the two charges for simultaneous activation upon triggering of the initiator.

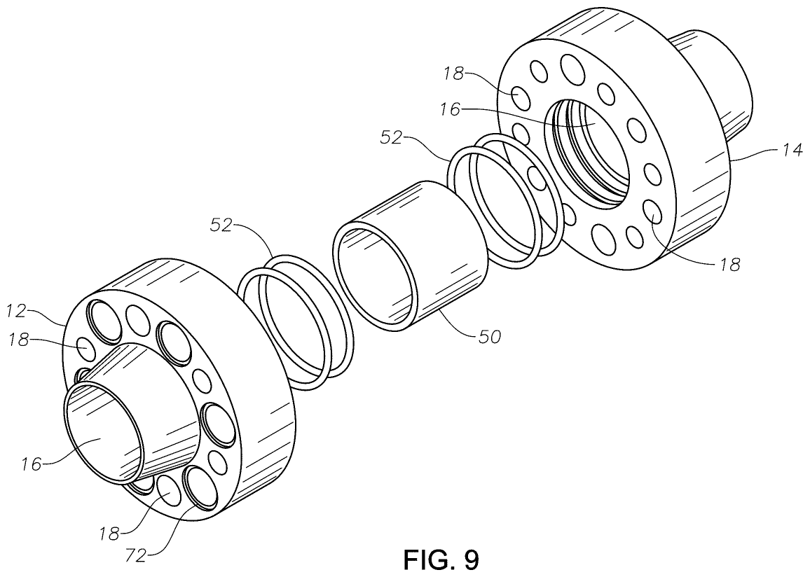

FIG. 8 shows a side view cross-section of another example conduit 10 according to this disclosure. This conduit 10 is similar to the conduit of FIG. 4 except without an inner sleeve in the primary through bore 16. This embodiment comprises a face seal 70 disposed in the primary through bore 16 at the junction 34 between the first 12 and second 14 coupling members. Lands 71A, 71B respectively formed on the first 12 and second 14 coupling members retain the seal affixed 70 in place. This embodiment allows the first 12 and second 14 coupling members to detach from one another without any hindrance upon activation of the explosively frangible fasteners 40 as described herein.

FIG. 9 shows an exploded view of first 12 and second 14 coupling member embodiments with an internal sleeve 50 according to this disclosure. Other components of the disclosed conduits are not shown for clarity of illustration. As shown in FIG. 9, embodiments may be implemented with threaded ports 72 leading into the secondary through bores 18 to receive sealing covers 20 and/or sleeves 30A, 30B (see FIG. 3) configured with complementary threading.

FIG. 10 shows a schematic of a conduit 10 embodiment coupled in a fluid conveyance system 100 disposed underwater. The system 100 comprises a floating platform 102 extending a riser 104 below the water surface to link with a BOP stack 106. The stack 106 includes a pair of BOPs 108, a conventional angle detection unit 110, and a controller 112 configured with electronics and software to convey a triggering signal to the conduit 10 when explosive separation of the conduit 10 is required. The controller 112 may comprise any suitable microcomputer, field programmable gate array, or microprocessor to perform the operations disclosed herein. It will be appreciated by those skilled in the art that the controller 112 may be located on the stack 106 or remotely from the stack (e.g. on the platform 102) with signal communication conveyed wirelessly or via cabling run along the riser 104. It will also be appreciated that the electric power source to trigger activation of the explosive charges 68 may be located locally on the stack 106 (e.g. via a battery) or supplied from a remote source via conventional cabling. The controller 112 may also be programmed to autonomously trigger simultaneous activation of all the explosive charges 68 or in a sequential pattern upon activation by the angle detection unit 110 or upon receipt of a triggering signal communicated from the floating platform 102. It will also be appreciated by those skilled in the art that the riser 104 and external lines connecting to the secondary through bores 18 may be permanently affixed to the conduits 10 via conventional techniques (e.g., pin-cup threaded connections, welding, locking mating surfaces, etc.).

In light of the principles and example embodiments described and illustrated herein, it will be recognized that the example embodiments can be modified in arrangement and detail without departing from such principles. It will be appreciated by those skilled in the art that conventional electronics, software, controllers, and components may be used to implement the embodiments according to this disclosure. It will also be appreciated that conduit 10 components may be formed of any suitable materials (e.g., metal, composites, plastics, etc.).

It will also be appreciated that embodiments of this disclosure may be implemented for use at surface as well as in underwater applications and operations, in the oil and gas industry, and in other fields of endeavor. For purposes of defining the scope of this disclosure, any embodiment referenced herein is freely combinable with any one or more of the other embodiments referenced herein, and any number of features of different embodiments are combinable with one another, unless expressly stated otherwise. It will also be appreciated that embodiments may be implemented using conventional processors and memory in applied computer systems. What is claimed as the invention, therefore, are all implementations that come within the scope of the following claims.

What is claimed is:

1. A rapidly separable conduit comprising:
a first coupling member;
a second coupling member configured to connect with the first coupling member to form a fluid conduit having a primary through bore;
wherein the first and second coupling members are each configured with passages to form at least one secondary through bore separate and apart from the primary through bore;
wherein the first and second coupling members are configured to accept at least one explosively frangible fastener to maintain the first and second coupling members joined to one another when the fluid conduit is formed;
wherein the at least one explosively frangible fastener is configured for electronic triggering to set off an explosive charge disposed thereon;
wherein the explosively charge is sealed off from the external environment when the fluid conduit is formed.

2. The rapidly separable conduit of claim 1 wherein the first and second coupling members are configured to accept a plurality of explosively frangible fasteners to maintain the first and second coupling members joined to one another, with the plurality of fasteners being sealed off from the external environment when the fluid conduit is formed.

3. The rapidly separable conduit of claim 2 wherein the plurality of explosively frangible fasteners are configured for selective activation.

4. The rapidly separable conduit of claim 2 wherein the plurality of explosively frangible fasteners each comprise a nut configured for electronic triggering to set off an explosive charge disposed on each nut.

5. The rapidly separable conduit of claim 1 wherein the first and second coupling members are each configured with passages to form a plurality of secondary through bores separate and apart from the primary through bore, with the plurality of secondary through bores configured to surround the primary through bore.

6. The rapidly separable conduit of claim 5 wherein the first and second coupling members are each configured with ports to permit external connections for separate fluid passage through the primary through bore and/or the plurality of secondary through bores.

7. The rapidly separable conduit of claim 5 wherein each secondary through bore is configured to receive a sleeve configured for disposal within the bore.

8. The rapidly separable conduit of claim 1 wherein the at least one explosively frangible fastener comprises an explosively frangible nut configured with at least two explosive charges disposed thereon.

9. The rapidly separable conduit of claim 8 further comprising a pyrotechnic crossover disposed on the explosively frangible nut to link the at least two explosive charges on the nut such that activation of one explosive charge sets off activation of each linked explosive charge.

10. The rapidly separable conduit of claim 1 wherein the first or second coupling member is configured with at least one recess to house the explosive charge to seal the charge off from the external environment.

11. The rapidly separable conduit of claim 1 further comprising a sleeve configured for disposal within the primary through bore.

12. The rapidly separable conduit of claim 1 wherein the first and second coupling members are configured for coupling to a fluid conveyance system comprising a blowout preventer and/or a riser.

13. The rapidly separable conduit of claim 1 further comprising an angle detection system linked in communication to the at least one explosively frangible fastener to trigger activation of the explosive charge disposed on the fastener.

14. A method for rapidly separating a conduit, comprising:
electronically triggering the detonation of an explosive charge on one or more explosively frangible fasteners disposed on a conduit comprising a first coupling member connected to a second coupling member;
wherein the explosive charge is sealed off from the external environment;
wherein the conduit comprises a primary through bore for fluid passage and at least one secondary through bore for fluid passage separate and apart from the primary through bore; and
permitting separation of the first coupling member from the second coupling member upon the detonation of the explosive charge on the one or more explosively frangible fasteners on the conduit.

15. The method of claim 14 wherein the conduit comprises a plurality of explosively frangible fasteners with each fastener having an explosive charge disposed thereon, and selectively activating the detonation of the explosive charges.

16. The method of claim 14 wherein the conduit comprises a plurality of secondary through bores separate and apart from the primary through bore, each secondary through bore configured for fluid passage therethrough.

17. The method of claim 16 comprising coupling the conduit to a fluid conveyance system to permit fluid passage through the primary through bore and/or the plurality of secondary through bores prior to electronically triggering the detonation of the explosive charge on the one or more explosively frangible fasteners.

18. The method of claim 17 wherein the fluid conveyance system comprises a blowout preventer and/or a riser.

19. The method of claim 14 wherein the conduit is configured to receive a signal relayed from an angle detection system to electronically trigger the detonation of the explosive charge on the one or more explosively frangible fasteners.

20. The method of claim 14 wherein the first or second coupling member of the conduit is configured with a recess to house the explosive charge to seal off the charge from the external environment.
